(19) United States
(12) Patent Application Publication
(10) Pub. No.: US 2016/0155477 A1
(43) Pub. Date: Jun. 2, 2016

(54) Identifying Media Types

(71) Applicant: MICROSOFT CORPORATION, Redmond, WA (US)

(72) Inventor: Kilroy Hughes, Seattle, WA (US)

(73) Assignee: MICROSOFT CORPORATION, Redmond, WA (US)

(21) Appl. No.: 14/557,425

(22) Filed: Dec. 1, 2014

(51) Int. Cl. G11B 27/30; G11B 27/10; G11B 27/22

(52) U.S. Cl. CPC G11B 27/30; G11B 27/22; G11B 27/102

(57) ABSTRACT

In one example, a media playback system may use media track parameters to more efficiently process a media data set. A media playback system may associate a media track parameter describing a media track with a media container containing the media track. The media playback system also may determine a media track characteristic based on the media track parameter. The media playback system further may execute a media track selection for the media container based on the media track characteristic, and perform a playback operation on the media track based on an outcome of the media track selection.

### BACKGROUND

A media container is a file, folder, or other data set that contains one or more different subsets of media data. Examples of media data include text, images, video, and audio. The media data may be arranged into tracks. A track is a time synchronized subset of media data such as audio, video, or subtitles. A computing device may use the media container to store one or more media tracks for processing and presentation to a user. Additionally, a computing device may use the media container to transmit media over a data network, such as the internet.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Examples discussed below relate to using media track parameters to more efficiently process a media data set. A media playback system may associate a media track parameter describing a media track with a media container containing the media track. The media playback system also may determine a media track characteristic based on the media track parameter. The media playback system further may execute a media track selection for the media container based on the media track characteristic, and perform a playback operation on the media track based on an outcome of the media track selection.

### DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 illustrates, in a block diagram, one example of a media data network.

FIG. 2 illustrates, in a block diagram, one example of a computing device.

FIG. 3 illustrates, in a block diagram, one example of a media container architecture.

FIG. 4 illustrates, in a block diagram, one example of a media parameter set.

FIG. 5 illustrates, in a flowchart, one example of a method for accessing a media container over a data network.

FIG. 6 illustrates, in a flowchart, one example of a method for performing a media track selection having identified a media track parameter set.

FIG. 7 illustrates, in a flowchart, one example of a method for providing one or more media data tracks in a presentation.

FIG. 8 illustrates, in a flowchart, one example of a method for accessing a media container in a data storage.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a machine-implemented method, a tangible machine-readable medium having a set of instructions detailing a method stored thereon for at least one processor, or a media playback system.

A comprehensive system of media parameters identify the media format of the multimedia files and streams contained in a media container. The media parameters may align with a standard set associated with the Internet Assigned Numbers Authority (IANA) Internet Media Types, with values for each parameter specified by designated and dynamically-updated registries. In addition to using these media parameters to identify the media container, a media source or a data storage may use the media parameters to identify media data on a track level within the media container. The media source or data storage may maintain or reference the media parameters associated with a media type in a hypertext transfer protocol (HTTP) header, a web page, a media file, a download manifest, a streaming manifest, a descriptive metadata document, or other descriptive data structure.

The IANA originally used multi-purpose internet mail extensions (MIME) types to combine independent files and objects, such as images, text, email, web pages, and other media data sets. Generic and multimedia containers, such as Zip or Moving Picture Experts Group (MPEG) version 2 (MPEG-2) Program Stream, introduced ambiguity in identifying the container and the included contents. The MIME type were assigned to a Moving Picture Experts Group Version 4 (MP4) file (MPEG-4 Part 14 or MPEG-4 Part 12, according to the International Organisation Standard (ISO) Base Media File Format) file according to the contents of the file. For example, if the file contains neither visual nor audio presentation, the assigned MIME type was application/mp4. If the file contains audio, but no visual presentation, the assigned MIME type was audio/mp4. If the file contains video, the assigned MIME type was video/mp4. The MIME type of the container was modified to identify the container's contents. For example, a video in a MPEG-2 Transport Stream was identified as video/MP2T.

This identification scheme provided basic information for media containers as to a few general types of content, but was of limited use for media containers that contained unknown or varied content. A MIME type of video/mp4 provides no indication to a playback device if an audio track or subtitles are included, or if audio or video is in a format that is decodable and presentable upon downloading. While a media parameter for the container has been specified that may describe a codec for a mp4 MIME type, the media parameter does not provide sufficient information to match the codec with a track or determine track streamability, track decryption, or track content (e.g. language).

By creating a standardized set of media parameters describing a media data set on a track level basis, a media playback system may enable independently created content and players to interoperate and provide a reliable playback experience to consumers across media container types. The media track parameters may specify track features, such as content identification; content encryption; language of subtitle, audio, and text tracks; track function or role (such as dialog, narration, description for the visually impaired, and the like); visual spatial resolution; audio quality levels; or other track characteristics. By declaring media track parameters, the media source may structure a media container to provide a single encoding of media tracks as a multitrack media container deliverable via multiple download formations, including individual tracks and combination of tracks. The media track parameters may identify container, content, languages, codecs, encoding profiles, encryption, image resolution, audio channels, or other data to allow selections and processing of appropriate tracks.

The media parameter may have a media type that identifies the container brand and the overall media type, such as audio or video. The media parameters may describe both a container level and a track level. The media container parameter may have a media container profile that describes the file type and brand of the media container, such as MP4, ISO Media Base File Format, Zip or MPEG-2 Program Stream. The media track parameter may have a profile indicator describing the track, a codec parameter describing the codec used for decoding the track, a content parameter identifying content, an auxiliary data parameter describing embedded encoding, language parameters describing the languages used, or a protection parameter describing encryption. The media source may code each media track parameter as a string, avoiding special characters. The media source may list the media track parameters as a comma delimited list in order of track identifier, or as an array with a parameter set for each track. The media source may identify a media track parameter as a reference numeral or designation that references a dynamically-updated, global parameter registry associating the reference number or designation with a media track parameter description.

The media source may include in the media container a content information box specified to convey content identification and interoperability information in a file header. The media playback system may read the content information box from a media container during playback. Alternately, the media source may create the content information box when the media container is encoded and packaged. The media source may then convey the content and encoding information to databases, manifests, and metadata later in the distribution process. Additionally, the content information box may include version numbers for the media container profile to distinguish between versions of the media container brand. The content information box may reference a dynamically-updated, global parameter registry associating a parameter number or designation with a media track parameter description.

The media playback system may perform a media playback operation to present the media to a user. A media playback operation processes a media track to decode the media data and render that a media in a format discernible by the user. The media playback system may perform a media track selection to determine which media track to select. A media track selection determines which media track in a media container to retrieve based on content and usability. For playback of tracks stored on a server, the media playback system may analyze the media track parameters to determine selected tracks before a media container is downloaded and processed to determine the media content. For example, a media track selection may be based on an interoperability determination that examines whether the media playback system has the infrastructure to process a media track, such as having the proper decoder. Additionally, a media track selection may be based on a content selection that results in the selection of the media track presented to the user based on the type or subject matter of the media data, such as language. The media track selection uses the media track characteristics described by the media track parameter to perform these tasks, as a media container MIME type does not contain sufficient detail to perform this function properly.

The media playback system may recursively select multiple tracks off of a media container manifest. A media container may offer multiple video tracks, for such features as Picture in a Picture, multiple camera angles, multiple audio, a commentary or narration track, or music tracks. When the media playback system downloads a multitrack file, track choices may be limited to the tracks in the file. The media playback system may use the elementary stream parsing to determine encryption and encoding format compatibility. For adaptive streaming, the media source may store dozens of tracks, with each independently selectable and “late bound” by time synchronization when played to the user. A media manifest may contain sufficient parameters for the media playback system to make track selections prior to downloading the media. A track level media parameter may improve track selection over selection by a container level media parameter. The media source may record that information to accurately replicate the media track parameter in a manifest, so that the encoder, streaming protocol, and media playback system may use the same parameter set, as specified in a dynamically-updated, global parameter registry.

Thus, in one example, a media playback system may use media track parameters to more efficiently process a media data set. A media playback system may associate a media track parameter describing a media track with a media container containing the media track. The media playback system also may determine a media track characteristic based on the media track parameter. The media playback system further may execute a media track selection for the media container based on the media track characteristic, and perform a playback operation on the media track based on an outcome of the media track selection.

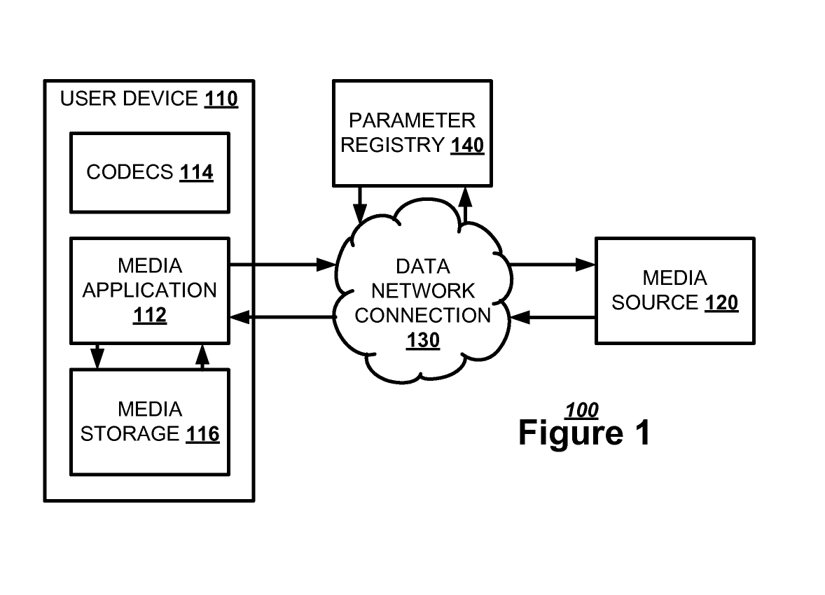

FIG. 1 illustrates, in a block diagram, one example of a media data network 100. A media playback system is a user device 110 that executes a media application 112 to present the media data contained in a media container. The media application 112 may use a codec 114 to process the media data in the media container. A codec 114 is a software, hardware, or firmware application that encodes or decodes digital data. The user device 110 may store the media container on a media storage 116 located on the user device 110. Alternately, the user device 110 may access the media container stored on a media source 120 via a data network connection 130. The media source 120 may be a single server or a distributed set of servers that may access a media data set, such as a server farm. The data network connection 130 may be an internet connection, a wide area network connection, a local area network connection, or other type of data network connections. The media application 112 may access a media track parameter describing the media container on a track level. The media track parameter may be a parameter number or a parameter designation referencing an entry in a dynamically-updated, global parameter registry 140. The global parameter registry 140 may store media track parameters across different media container types.

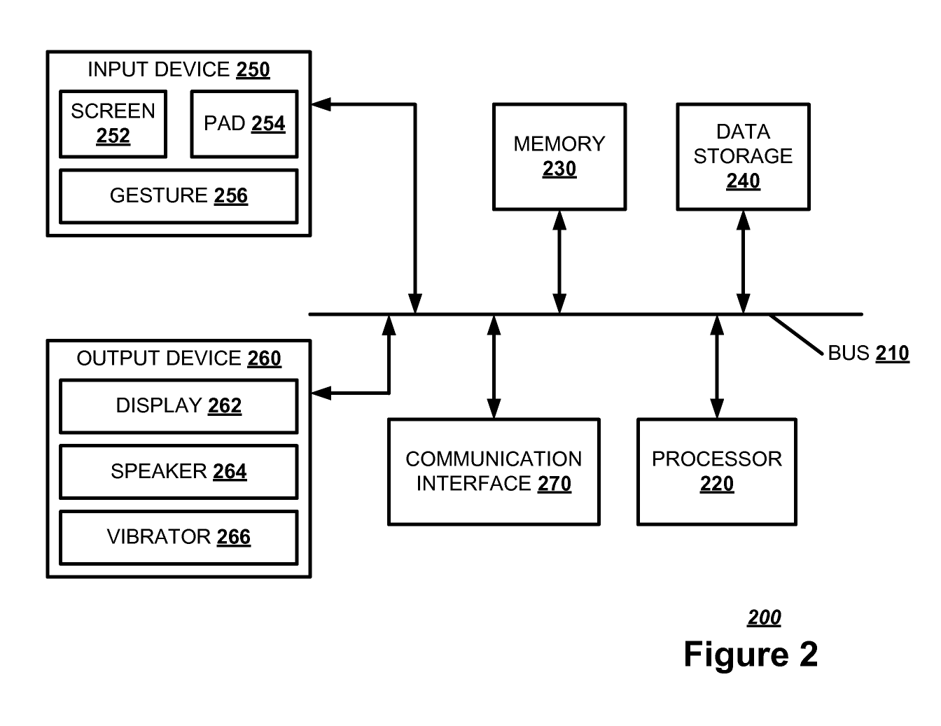

FIG. 2 illustrates a block diagram of an exemplary computing device 200 which may act as a media playback system or a media source. The computing device 200 may combine one or more of hardware, software, firmware, and system-on-a-chip technology to implement a media playback system or a media source. The computing device 200 may include a bus 210, a processor 220, a memory 230, a data storage 240, an input device 250, an output device 260, and a communication interface 270. The bus 210, or other component interconnection, may permit communication among the components of the computing device 200.

The processor 220 may include at least one conventional processor or microprocessor that interprets and executes a set of instructions. The processor may be configured to execute a media application 112. The media application 112 may determine a media track characteristic based on a media track parameter. The media application 112 may execute a media track selection for the media container based on the media track characteristic. The media application may perform a playback operation on the media track based on an outcome of the media track selection. The media application may perform an interoperability determination for the media container based on the media characteristic. The media application may identify available codecs for the media track in the media container. The media application may perform a content selection from the media container based on the media track characteristic.

The memory 230 may be a random access memory (RAM) or another type of dynamic data storage that stores information and instructions for execution by the processor 220. The memory 230 may also store temporary variables or other intermediate information used during execution of instructions by the processor 220. The memory 230 may be configured to associate a media container profile describing the media container with the media container. The memory 230 further may be configured to associate a media track parameter describing a media track with a media container containing the media track. The memory 230 also may be configured to maintain the media track parameter in at least one of a metadata file and a content information box.

The data storage 240 may include a conventional ROM device or another type of static data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may be configured as a media storage 116 to store a media container. The data storage 240 may also be a database or a database interface for storing a media container.

The input device 250 may include one or more conventional mechanisms that permit a user to input information to the computing device 200, such as a keyboard, a mouse, a voice recognition device, a microphone, a headset, a touch screen 252, a touch pad 254, a gesture recognition device 256, etc. The output device 260 may include one or more conventional mechanisms that output information to the user, including a display screen 262, a printer, one or more speakers 264, a headset, a vibrator 266, or a medium, such as a memory, or a magnetic or optical disk and a corresponding disk drive.

The communication interface 270 may include any transceiver-like mechanism that enables computing device 200 to communicate with other devices or networks. The communication interface 270 may include a network interface or a transceiver interface. The communication interface 270 may be a wireless, wired, or optical interface. The communication interface 270 may be configured to receive the media track parameter in a media manifest for the media container from a media source. The communication interface 270 may be configured to request the media track from the media source based on the media track selection. The communication interface 270 may be configured to acquire a codec for the media track based on the media track selection. The communication interface 270 may be configured to access a dynamically-updated, global parameter registry 140 to match a reference numeral or designation to a track parameter description.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 270.

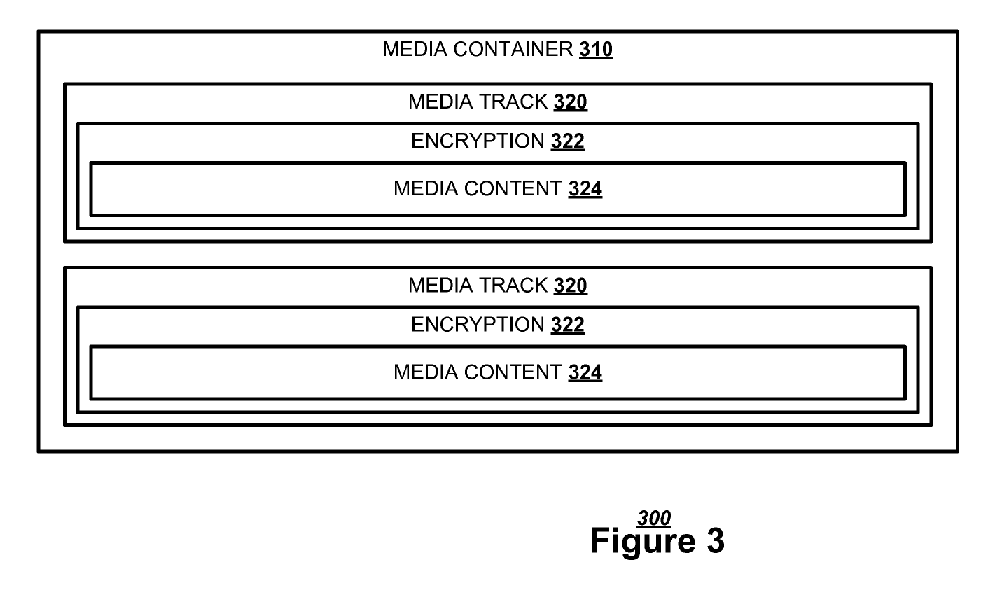

FIG. 3 illustrates, in a block diagram, one example of a media container architecture 300. A media container 310 is file, folder, or other data group containing a media data set. The media container 310 may contain one or more media tracks 320. Each media track 320 is a media stream, a media file, or other media data structure representing a timed presentation aspect of the media container 310. For example, if the media container 310 contains a video data set, the media track 320 may represent an audio track, a video track, a caption track, a sequence of still images, a language translation track, a music track, a video chapter, or ad markers. A media stream is a media signal that may be transmitted over a network. A media file is a media data structure that may be stored in a data storage. The media track 320 may have an encryption 322 applied to a set of media content 324. The encryption 322 is an encoding that is applied to the media content 324 to hide the data from unintended users.

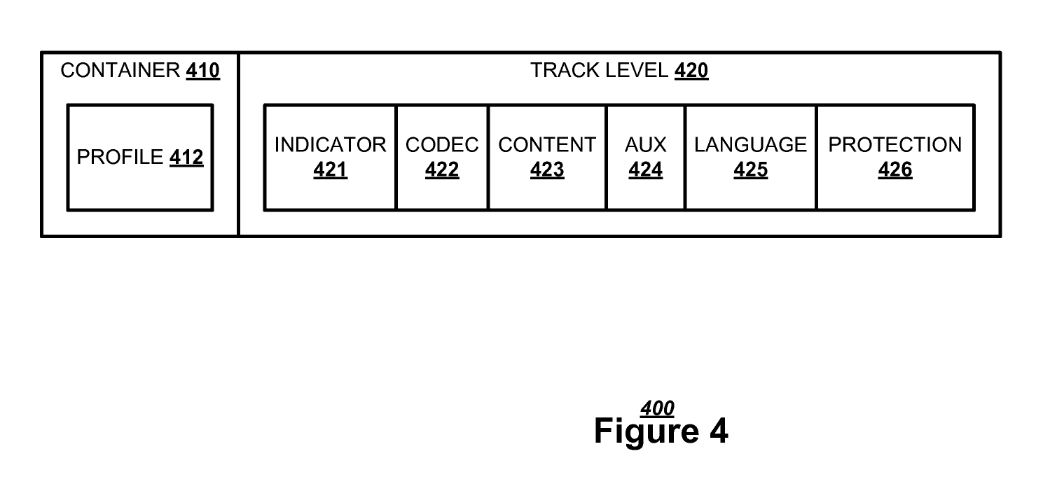

The media playback system may use a media parameter to describe a media container 310. FIG. 4 illustrates, in a block diagram, one example of a media parameter 400. The media parameter 400 may have a media container parameter 410 and a media track parameter 420. The media parameter 400 additionally may have further parameters describing the contents of the media container at a granular level of detail below the media track level. A media container parameter 410 is a descriptor of the media container, such as media container 310, at a container level. The media container parameter 410 may include a media container profile 412. The media container profile 412 is a file level descriptor that identifies the container structure. The media container profile 412 may be a brand registered with the MPEG-4 Part 12 Registration Authority (MP4RA.org).

A media track parameter 420 is a descriptor of a media track, such as media track 320, at a track level. The media track parameter 420 may include a media format profile indicator 421, a codec parameter 422, a content parameter 423, an auxiliary data parameter 424, a language parameter 425, a protection parameter 426, or other track descriptor. A media format profile indicator 421 describes the media track type and track constraints, such as identifying a video track, an audio track, or subtitle track conforming to a particular media format interoperability profile. A codec parameter 422 describes the type of codec that decodes the media track, possibly including features such as a codec profile and level, display or speaker characteristics, or other features. A content parameter 423 differentiates between media tracks of the same media type, such as identifying different camera angles in a video. An auxiliary data parameter 424 describes any additional presentation data embedded in a media track, such as closed captioning or stereoscopic disparity data. A language parameter 425 describes the associated languages of a media track, such as English, Spanish, or Mandarin. A protection parameter 426 describes the encryption, such as encryption 322, applied to the content of the media track.

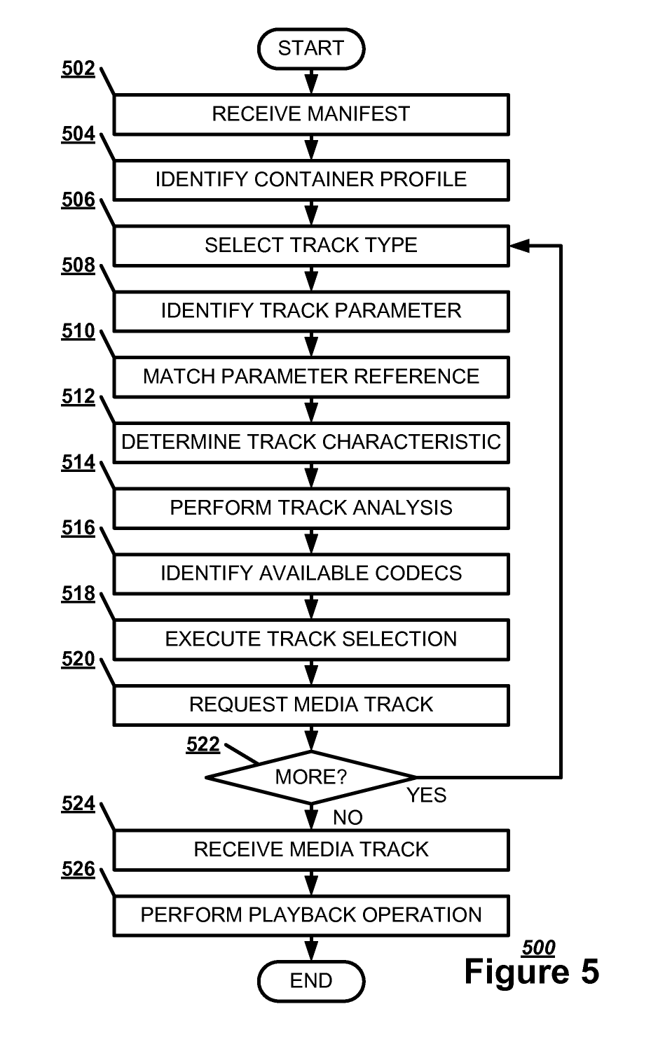

FIG. 5 illustrates, in a flowchart, one example of a method 500 for accessing a media container over a data network. A media playback system receives a media manifest for a media container containing a media track from a media source (Block 502). The media playback system identifies a media container profile associated with the media container describing the media container in the media manifest (Block 504). The media playback system may select a track type for a media track to request from the media source (Block 506). The media playback system identifies a media track parameter describing the media track associated with the media container in the media manifest (Block 508). The media playback system may match a track parameter reference in the media track parameter to a media track parameter description at a global parameter registry (Block 510). The media playback system determines a media track characteristic based on the media track parameter (Block 512). The media playback system performs a media track analysis of the media track characteristic (Block 514). The media playback system may identify available codecs in the media playback system for the media track in the media container (Block 516). The media playback system executes a media track selection for the media container based on the media track analysis of the media track characteristic (Block 518). The media playback system requests the media track from the source based on an outcome of the media track selection (Block 520). If the media playback system seeks further media tracks (522), the media playback system may select a track type for a media track to request from the media source (Block 506). The media playback system receives the media tracks from the media source (Block 524). The media playback system performs a playback operation on the media track based on an outcome of the media track selection (Block 526).

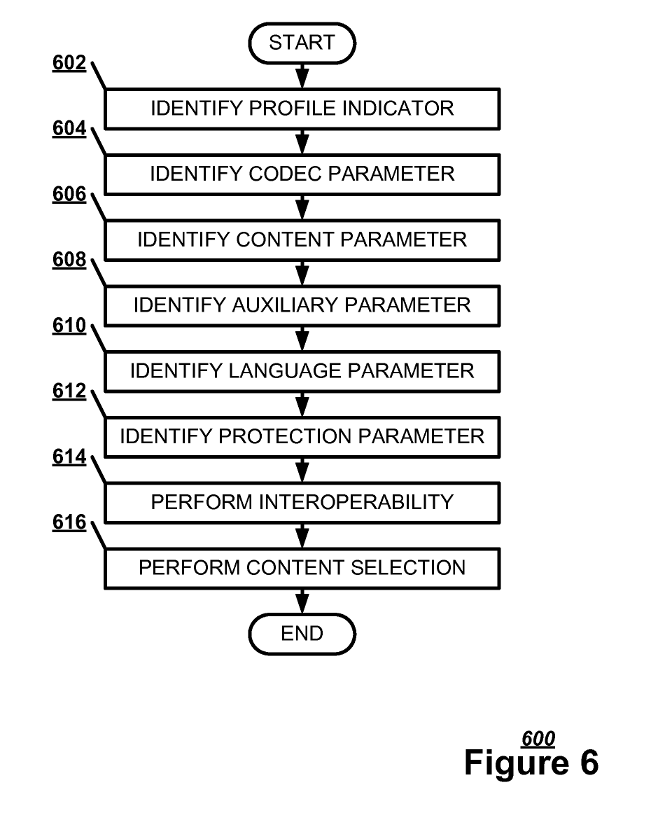

FIG. 6 illustrates, in a flowchart, one example of a method 600 for performing a media track analysis having identified a media track parameter. The media playback system identifies a profile indicator (Block 602). The media playback system identifies a codec parameter (Block 604). The media playback system identifies a content parameter (Block 606). The media playback system identifies an auxiliary data parameter (Block 608). The media playback system identifies a language parameter (Block 610). The media playback system identifies a protection parameter (Block 612). The media playback system performs an interoperability determination for the media container based on the media track characteristic (Block 614). An interoperability determination is a calculation that determines whether the media playback system has the infrastructure to process a media track, such as having the proper codec. The media playback system performs a content selection from the media container based on the media track characteristic (Block 616). A content selection is a choice of a set of specific content from the media container. For example, the media playback system may select a Spanish language track but not a Mandarin language track.

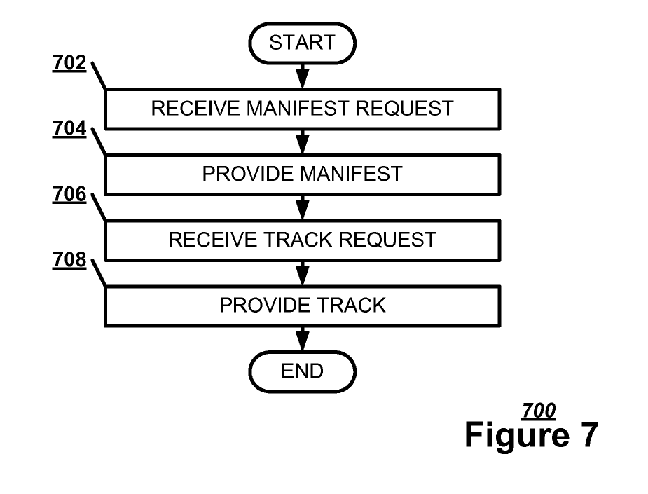

FIG. 7 illustrates, in a flowchart, one example of a method for providing a media data set. A media source, such as media source 120, may receive a media manifest request from a media playback system (Block 702). The media source may provide a media manifest describing a list of available media containers, along with the media tracks and associated media track parameters for each media container, to the media playback system (Block 704). The media source may receive one or more track requests from the media playback system based on a media track selection performed by the media playback system using the media track parameter (Block 706). The media source may provide the requested media track to the media playback system via download or streaming (Block 708).

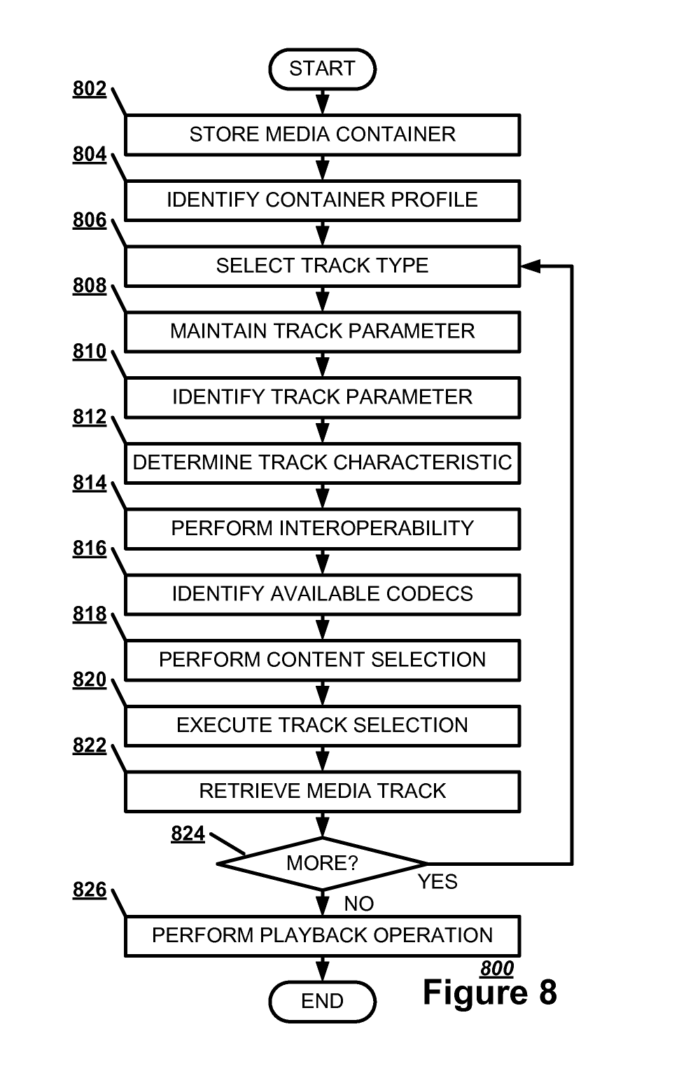

FIG. 8 illustrates, in a flowchart, one example of a method 800 for accessing a media container in a data storage. A media playback system stores a media container containing a media track in a data storage (Block 802). The media playback system identifies a media container profile associated with the media container describing the media container in the media manifest (Block 804). The media playback system may select a track type for a media track to request from the data storage (Block 806). The media playback system maintains a media track parameter in a metadata file or a content information box (Block 808). The media playback system identifies the media track parameter associated with the media container describing the media track in the media container (Block 810). The media playback system determines a media track characteristic based on the media track parameter, such as by matching a track parameter reference in the media track parameter to a media track parameter description at a global parameter registry (Block 812). The media playback system performs a media track analysis of the media track characteristic. For example, the media playback system may perform an interoperability determination for the media container based on the media track characteristic (Block 814). The media playback system may identify available codecs in the media playback system for the media track in the media container (Block 816). Also, the media playback system may perform a content selection from the media container based on the media track characteristic (Block 818). The media playback system executes a media track selection for the media container based on the media track analysis of the media track characteristic (Block 820). The media playback system retrieves the media track from the data storage based on the media track selection (Block 822). If the media playback system seeks further media tracks (824), the media playback system may select a track type for a media track to request from the data storage (Block 806). The media playback system performs a playback operation on the media track based on an outcome of the media track selection (Block 826).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Examples within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to carry or store desired program code means in the form of computer-executable instructions or data structures. Combinations of the above should also be included within the scope of the computer-readable storage media.

Examples may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described examples are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A media playback system, comprising:
a memory configured to associate a media track parameter describing a media track with a media container containing the media track; and
a processor configured to: determine a media track characteristic based on the media track parameter, execute a media track selection for the media container based on the media track characteristic, and perform a playback operation on the media track based on an outcome of the media track selection.

2. The media playback system of claim 1, wherein the memory is configured to associate a media container profile describing the media container with the media container.

3. The media playback system of claim 1, wherein the media track parameter includes at least one of a profile indicator, a codec parameter, a content parameter, an auxiliary data parameter, a language parameter, and a protection parameter.

4. The media playback system of claim 1, wherein the processor is further configured to perform an interoperability determination for the media container based on the media track characteristic.

5. The media playback system of claim 1, wherein the processor is further configured to identify available codecs for the media track in the media container.

6. The media playback system of claim 1, wherein the processor is further configured to perform a content selection from the media container based on the media track characteristic.

7. The media playback system of claim 1, further comprising:
a communication interface configured to receive the media track parameter in a media manifest for the media container from a media source.

8. The media playback system of claim 1, further comprising:
a communication interface configured to request the media track from a media source based on the media track selection.

9. The media playback system of claim 1, further comprising:
a data storage configured to store the media container.

10. The media playback system of claim 1, wherein the media track is at least one of a media stream and a media file.

11. The media playback system of claim 1, wherein the memory is further configured to maintain the media track parameter in at least one of a metadata file and a content information box.

12. A tangible machine-readable medium having a set of instructions detailing a method stored thereon that when executed by one or more processors cause the one or more processors to perform the method, the method comprising:
receiving a media manifest for a media container containing a media track from a media source;
identifying a media track parameter describing the media track associated with the media container in the media manifest;
determining a media track characteristic based on the media track parameter;
executing a media track selection for the media container based on the media track characteristic; and
performing a playback operation on the media track based on an outcome of the media track selection.

13. The tangible machine-readable medium of claim 12, wherein the method further comprises:
identifying a media container profile associated with the media container describing the media container in the media manifest.

14. The tangible machine-readable medium of claim 12, wherein the method identifying the media track parameter comprises:
identifying at least one of a profile indicator, a codec parameter, a content parameter, an auxiliary data parameter, a language parameter, and a protection parameter in the media manifest.

15. The tangible machine-readable medium of claim 12, wherein the method further comprises:
performing an interoperability determination for the media container based on the media track characteristic.

16. The tangible machine-readable medium of claim 12, wherein the method further comprises:
performing a content selection from the media container based on the media track characteristic.

17. The tangible machine-readable medium of claim 12, wherein the method further comprises:
requesting the media track from the media source based on the media track selection.

18. The tangible machine-readable medium of claim 12, wherein the method further comprises:
matching a track parameter reference in the media track parameter to a media track parameter description at a global parameter registry.

19. A machine-implemented method, comprising:
storing a media container containing a media track in a data storage;
identifying a media track parameter describing the media track associated with the media container;
determining a media track characteristic based on the media track parameter;
performing an interoperability determination for the media container based on the media track characteristic;
performing a content selection from the media container based on the media track characteristic;
executing a media track selection for the media container based on the media track characteristic; and
performing a playback operation on the media track based on an outcome of the media track selection.

20. The method of claim 19, further comprising:
retrieving the media track from the data storage based on the media track selection.
